(19) United States
(12) Patent Application Publication
(10) Pub. No.: US 2010/0101855 A1
(43) Pub. Date: Apr. 29, 2010

(54) CABLE RACEWAY WITH BOX

(76) Inventor: Jordan Handler, Rye Brook, NY (US)

Correspondence Address: OSTROLENK FABER GERB & SOFFEN, 1180 AVENUE OF THE AMERICAS, NEW YORK, NY, 100368403, US

(21) Appl. No.: 12/604,649

(22) Filed: Oct. 23, 2009

Related U.S. Application Data
(60) Provisional application No. 61/107,883, filed on Oct. 23, 2008.

(51) Int. Cl. H02G 3/22

(52) U.S. Cl. 174/505

(57) ABSTRACT

A combination of a cable raceway and a power device box where the cable raceway includes at least one and usually at least two compartments extending along a length of the raceway. The power device box includes a base unit. The compartment of the cable raceway includes a removable cover forming a wall of the raceway. The base unit extends over the compartment of the raceway and is secured to the raceway. A power device box base unit receives cables from the raceway.

### CROSS REFERENCE TO RELATED APPLICATION(S)

This Application claims priority and is entitled to the filing date of U.S. Provisional Application Ser. No. 61/107,883 filed Oct. 23, 2008 in the name of Jordan HANDLER, and entitled “CABLE RACEWAY WITH BOX”.

### BACKGROUND OF THE INVENTION

This present invention generally relates to raceways for conducting cables.

A conventional cable raceway includes a conduit for conducting cables along a building's wall, ceiling, or floor. Such raceway typically has one or more passages or compartments extending through the conduit along the raceway and through which cables or wires are conducted. Many current raceways accommodate power cables, data cables or a combination of both. Local building codes often require power and data cables to be segregated. Therefore, many raceways are divided internally to define separate passages.

At selected intervals, the raceway may have cable outlets. A power device to be connected to at least some of the cables is connected to a cable outlet at a side of the raceway, and respective cables exiting the raceway outlet are there connected to the device at the outlet.

Further, a power device typically includes a box shaped base unit to be connected with a cable raceway. A cover unit may be placed over the base unit. Such conventional device box base units typically have openings on their bottom sides, but are closed on all four lateral sides. Such a design requires that the wires or cables are threaded from the raceway outlets through bottom side openings of the device box base unit and cover unit and are then connected to the power or data devices.

### SUMMARY OF THE INVENTION

It is the object of the invention to provide a cable raceway in combination with a device box, where the cable raceway includes two defined and separated compartments extending along the length of the raceway. Each compartment has a removable cover forming a wall of the raceway. The device box includes a base unit open on three sides thereof and extending over the two compartments of the raceway by one open side of the base unit facing a wall, e.g., at the top of the raceway, so that cable from inside the raceway can pass out to the device base. The device box base unit is attached to the raceway by a plurality of feet located at the bottom of the base unit.

Other features and advantages of the present invention will become apparent from the following description of the invention which refers to the accompanying drawings.

### BRIEF DESCRIPTION OF THE DRAWINGS

FIG. 1 is a side view of the internal configuration of the cable raceway.

FIG. 2 is a top perspective view of the power device box showing the base unit.

FIG. 3 is a top perspective view of the cover unit.

FIG. 4 is a top perspective view of the cover unit with a mounted power device.

### DETAILED DESCRIPTION OF EMBODIMENTS OF THE INVENTION

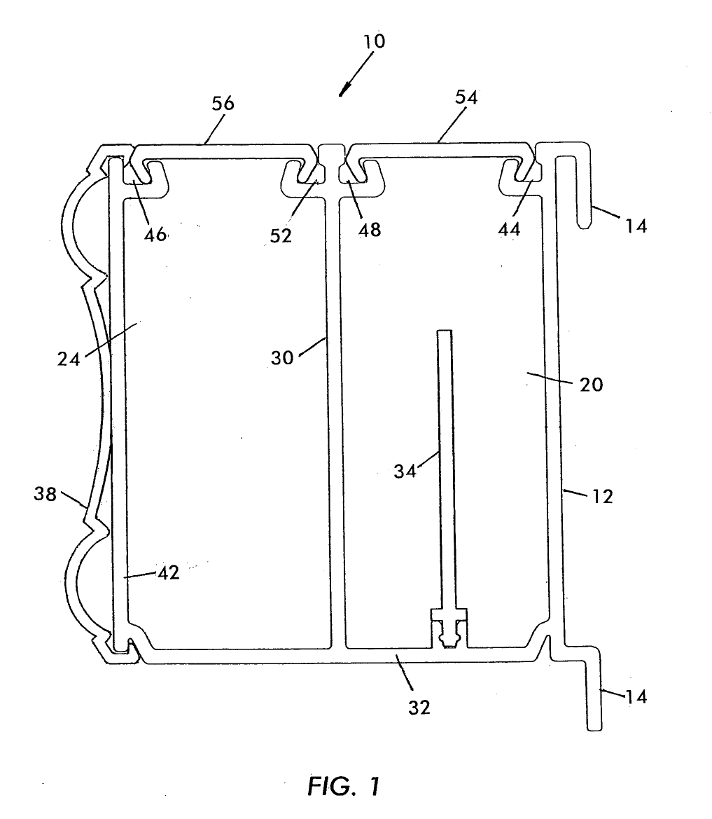

A preferred embodiment of the cable raceway 10 is shown in FIG. 1. The internal elements shown in FIG. 1 extend over the length of the raceway. Raceway 10 preferably includes a rear wall 12 which may be attached by flanges 14 to a structure wall, ceiling, or the like, not shown, on which the raceway is mounted. Raceway 10 also includes an inner, rear cable conduit or compartment 20 located closer to the structure wall and an outer, front cable conduit or compartment 24 located further from the structure wall. The compartments provide respective paths, for example, for two types of cable (not shown), e.g., power cable in one compartment and data cable in the other compartment. The compartments are separated by a divider 30 which extends the vertical height of the raceway, from its bottom wall 32 to the top of the compartments. This construction differs from a conventional construction of raceways, where dividers typically extend horizontally, i.e., from the rear wall of a raceway to its front wall, dividing the raceway into the compartments located one above another.

The inner compartment 20 has an optional additional vertical divider 34 removably installed for separating cables in that compartment 20. The divider may be placed in either compartment as an installation requires. An installable and removable ornamental cover 38 is preferably snap fit over the outer, front wall 42 of the outer compartment 24, thus forming a wall of the raceway.

The top ends of the compartments 20, 24 are open. The walls 12 and 42 are shaped to define respective snap in or slide in slots 44, 46 at their top ends and the divider 30 is shaped to define a pair of slots 48, 52 at its top end. The slots cooperate with installable and removable cover plates 54, 56 that span the open space between the slots and close the open top ends of the respective compartments.

The respective cover plates 54, 56 are attached to the top end slots of the inner and outer walls and to the divider and the cover plates cooperate with respective walls and the divider to define each of the two compartments. The plates 54, 56 define the top of the raceway. The plates may extend along the entire length of the raceway, and also may be partially removed or otherwise shaped to define openings through the plates (not shown) for cable outlet from each compartment at locations where a user of the raceway may select a particular application, typically for device boxes.

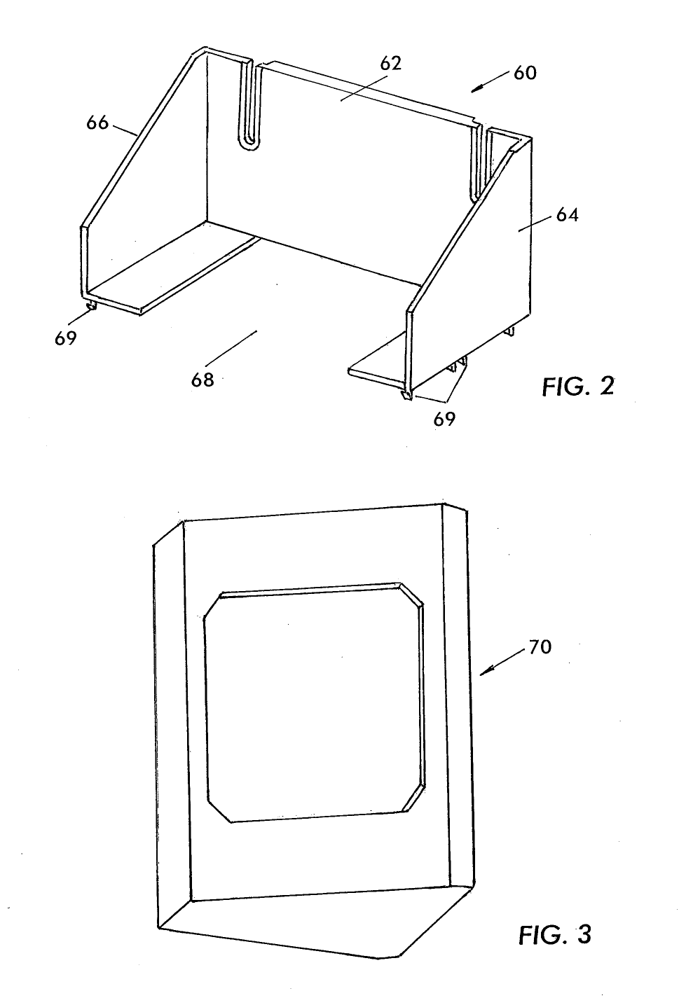

In accordance with the preferred embodiment, a conventional electrical and/or data device to be supplied by the cables (typically either power or data devices) is mounted in a power device box, shown in FIG. 2. The power device box includes a base unit 60, which is mounted on one side of the raceway. In the preferred embodiment, the base unit 60 is mounted at the top side of the raceway, so that cables exit upwardly if the raceway is not at the top of the structure wall or if the raceway is near the floor. If the raceway is positioned at the ceiling, to allow the cables to exit downward, the base unit is positioned at a bottom of the raceway, and the cable raceway is oriented so that the plates 54, 56 (shown at the top in FIG. 1) are located at the bottom of the raceway.

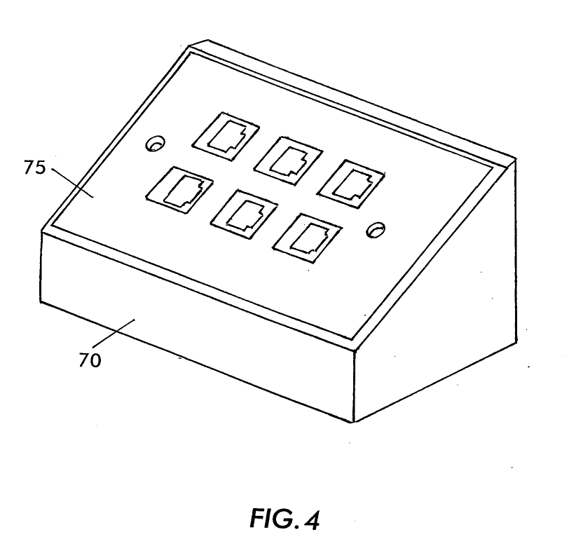

The power device box base unit 60 according to the preferred embodiment is shown in FIG. 2. Box unit 60 and a plate cover unit 70, a conventional example of which is shown in FIG. 3, house a power or data device 75 (shown in FIG. 4).

In contrast with conventional device boxes, the base unit 60 of the present power device box is preferably open on three sides to allow cables and devices to be connected to the device beforehand, likely with no cable threading needed. The device box is then directly placed onto the raceway. The base unit is oriented such that its rear wall 62 is at or near the raceway rear wall 12 and its sides 64, 60 project forward over the top of both compartments. The open base 68 of the base unit spans both raceway conduit compartments.

The plate cover unit 70 preferably has an open front, an outer side allowing power or data devices, which are already connected to wires or cables, to be mounted into the box by placing the cover unit 70 directly over the base unit 60. FIG. 4 shows a power device 75 mounted into the box and plate cover unit of FIG. 3.

The device box base unit 60 is preferably fastened to the top of the cable raceway 10 so as to resist pull out forces acting on the power device 75. The device box base unit is preferably secured to the raceway by feet 69 located at the bottom of the base unit. Feet 69 are preferably inserted and clipped into channels 44, 46, 48, 52 formed along the top of the raceway. Feet 69 clipped into the compartment channels of the raceway provide a positive locking mechanism for the box to counter pull out forces.

There are preferably eight feet 69 located below the underside of the device box base unit of FIG. 2, four on each side since the box extends out from a wall over both compartments of the raceway. Therefore, the base unit extends out over the area where cables exit from one of the compartments and over the neighboring area of the other compartment, where there is preferably a plate covering the top of this neighboring compartment. An installer may remove or snap off the four feet on top of the compartment that has the cover plate to ensure that the covered compartment is not accessed from that base unit. Then, only the four feet, which correspond with the compartment being accessed by the power device to be connected to cables, will be clipped into place at the top end channels of the raceway after the cover plate over that compartment is removed. Thus, the present device box is effective for use on a raceway that is more than one compartment wide, and is effective to enable connection of a device to cables redirected out of the raceway into the device box.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A combination of a cable raceway and a power device box, comprising:
the cable raceway including walls defining at least one compartment extending along a length of the raceway, the compartment having a removable cover forming one of the walls of the raceway; and
the power device box including
a base unit open on three sides thereof, the base unit extending over the compartment of the raceway and being secured to the raceway and one of the open sides of the base unit facing one of the walls of the raceway, and the one raceway wall having an opening communicating to the one open side of the base unit.

2. The combination of a cable raceway and a power device box of claim 1, wherein the cable raceway comprises a divider extending along the length of the raceway to define at least two of the compartments in the raceway and extending along the length of the raceway, the compartments being separated by the divider, and wherein the base unit of the power device box extends over both of the at least two compartments.

3. The combination of a cable raceway and a power device box of claim 2, wherein the compartments have a bottom side and a top side, the cover being at the top side, and the divider extends between the top and the bottom sides.

4. The combination of a cable raceway and a power device box of claim 3, wherein the cover comprises a respective one of the covers over each of the compartments.

5. The combination of a cable raceway and a power device box of claim 2, wherein the cover comprises a respective one of the covers over each of the compartments.

6. The combination of a cable raceway and a power device box of claim 5, wherein the cable raceway further comprises an attachable and detachable front plate which when attached to the raceway encloses a front wall of one of the compartments.

7. The combination of a cable raceway and a power device box of claim 2, wherein the base unit has a plurality of feet positioned at the one open side of the base unit and shaped and operable for securing the base unit to the cable raceway.

8. The combination of a cable raceway and a power device box of claim 7, wherein some of the plurality of feet of the base unit are removable for providing the open side of the box with a configuration not to interfere with placement and removal of the covers on the compartments.

9. The combination of a cable raceway and a power device box of claim 7, wherein one of the walls of each compartment includes channels running along at least one side of the raceway, and the feet of the base unit being positioned, configured and operable to clip into the channels of the compartments of the raceway.

10. The combination of a cable raceway and a power device box of claim 2, wherein the compartments are positioned side by side from the front to a rear of the raceway.

11. The combination of a cable raceway and a power device box of claim 1, further comprising a cover unit housing a power device, the cover unit being configured to be placed into the base unit, and the cover unit having an open side configured for access to the power device.

12. The combination of a cable raceway and a power device box of claim 1, wherein the removable cover extends over a top side of the raceway.
